(19) United States
(12) Patent Application Publication
(10) Pub. No.: US 2026/0304181 A1
(43) Pub. Date: Oct. 1, 2026

(54) UE Applicability Reporting for Inference Set Parameters and Associated ID via Bitmap Signaling in AI Beam Management

(71) Applicant: Apple Inc., Cupertino, CA (US)

(72) Inventors: Konstantinos SARRIGEORGIDIS, Los Gatos, CA (US); Jie CUI, San Jose, CA (US); Manasa RAGHAVAN, Sunnyvale, CA (US); Qiming LI, Beijing (CN); Rolando E BETTANCOURT ORTEGA, Munich (DE); Wanshi CHEN, San Diego, CA (US); Xiang CHEN, Palo Alto, CA (US); Yang TANG, San Jose, CA (US); Yuexia SONG, Beijing (CN)

(21) Appl. No.: 19/181,647

(22) Filed: Apr. 17, 2025

(30) Foreign Application Priority Data
Mar. 26, 2025 (GR) 20250100227

(51) Int. Cl. H04W 24/10; H04B 7/06

(52) U.S. Cl. CPC H04W 24/10; H04B 7/0626; H04B 7/06952

(57) ABSTRACT

An apparatus configured to process, based on signaling from a network, a configuration for reporting applicable functionalities for models, the configuration including at least one associated identifier (ID) for models supported by the network or at least one parameter set including the associated ID, each associated ID associated with parameters related to beam transmission during inference operations and generate a bitmap in which each bit indicates whether a respective associated ID or respective parameter set is supported

### BACKGROUND

Artificial intelligence (AI) and/or machine learning (ML) processes, e.g., deep learning neural networks, may be used to augment operations for the air interface in a cellular radio access network (RAN), e.g., 5G New Radio (NR) RAN, 6G RAN, etc. The use cases of AI/ML for the air interface include beam management (BM).

### SUMMARY

Some example embodiments are related to an apparatus having memory coupled to processing circuitry, the processing circuitry configured to process, based on signaling from a network, a configuration for reporting applicable functionalities for models, the configuration including at least one associated identifier (ID) for models supported by the network or at least one parameter set including the associated ID, each associated ID associated with parameters related to beam transmission during inference operations and generate a bitmap in which each bit indicates whether a respective associated ID or respective parameter set is supported.

Other example embodiments are related to method for processing, based on signaling from a network, a configuration for reporting applicable functionalities for models, the configuration including at least one associated identifier (ID) for models supported by the network or at least one parameter set including the associated ID, each associated ID associated with parameters related to beam transmission during inference operations and generating a bitmap in which each bit indicates whether a respective associated ID or respective parameter set is supported.

### BRIEF DESCRIPTION OF THE DRAWINGS

FIG. 1 shows a diagram of spatial domain prediction according to one example.

FIG. 2 shows a diagram of temporal domain prediction according to one example.

FIG. 3 shows a signaling diagram for activating a functionality according to one example.

FIG. 4 shows three example sets of inference-related parameters indicated by a network to a UE in a request for applicable functionalities according to various example embodiments.

FIG. 5 shows a diagram of an example training phase in which the same associated ID is associated with multiple data collection configurations and an example inference configuration indicating one of the data collection configurations according to various example embodiments.

FIG. 6a shows CSI report configurations for inference including bitmaps indicating sets of inference parameters according to various example embodiments.

FIG. 6b shows a signaling diagram for indicating an inference model according to various example embodiments.

FIG. 7 shows an example network arrangement according to various example embodiments.

FIG. 8 shows an example UE according to various example embodiments.

FIG. 9 shows an example base station according to various example embodiments.

### DETAILED DESCRIPTION

The example embodiments may be further understood with reference to the following description and the related appended drawings, wherein like elements are provided with the same reference numerals. The example embodiments relate to operations for applicability reporting for models employed by a user equipment (UE) for beam management (BM). In some example embodiments, the models can be artificial intelligence and/or machine learning (AI/ML) models. In other example embodiments, the models can be deterministically derived models(e.g., look up table, matrices, etc.). In particular, the example embodiments relate to operations for a network to trigger the UE to report applicable functionalities in view of network-side additional conditions indicated by the network by an associated identifier (associated ID) and/or a set of inference-related parameters. In some example embodiments, the UE may report applicable functionalities by a bitmap mapping to associated IDs and/or inference-related parameter sets. In further example embodiments, operations are described for configuring the UE for inference based on the applicable functionalities reported by the UE.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange signaling and/or data with the network. Therefore, the UE as described herein is used to represent any electronic component.

The example embodiments are also described with reference to a 5G New Radio (NR) network. However, reference to a 5G NR network is merely provided for illustrative purposes. The example embodiments may be utilized with any network implementing AI/ML beam management functionalities similar to those described herein, e.g., 5G-Advanced network, 6G network, etc. Therefore, the 5G NR network as described herein may represent any type of network implementing AI/ML beam management functionalities similar to the 5G NR network.

The example embodiments are also described with regard to radio resource management (RRM), in particular, beam management (BM). Beam management generally refers to a set of procedures configured to acquire and maintain a beam between a base station or TRP and a UE. The terms P1, P2 and P3 refer to processes for beam management during initial access and while in the CONNECTED state. In the P1 process, the base station (e.g., gNB) performs Tx beam sweeping of synchronization signal blocks (SSBs), typically from a set of different beams, and the UE performs reception (Rx) wide beam sweeping from a set of different beams. The UE measures the signal strength (e.g., Reference Signal Received Power (RSRP)) of each of the SSBs of the received beams and selects the best beam to report to the gNB. In the P2 process, the gNB performs beam refinement by performing Tx beam sweeping of Channel State Information-Reference Signal (CSI-RS), possibly from a smaller set of beams than the P1 process, and the UE performs Rx wide beam sweeping from a set of different beams. The P2 Tx beam sweeping may be narrower than that of P1. The UE measures the signal strength (e.g., RSRP) of the CSI-RS of the received beams and selects the best beam to report to the gNB. In the P3 process the gNB (TRP) repeatedly transmits the same Tx beam and the UE refines its Rx beam.

The example embodiments are also described with regard to AI/ML-based beam management (BM). An AI/ML model may be employed for beam prediction to reduce overhead/latency and improve beam selection. The AI/ML model may be employed for beam prediction in the time domain and/or the spatial domain. In both cases, a set of downlink beams may be measured and used as input to the AI/ML model to predict the best beam within another set of downlink beams. In some example embodiments, the measured parameter/quantity may be L1-RSRP. However, the example embodiments are not limited to this parameter. The measured set of downlink beams may be referred to as “Set B” and the predicted set of downlink beams may be referred to as “Set A.” Set B may be a subset of Set A, or Set B may be different from Set A. For example, the base station may be capable of transmitting 64 beams, but the base station may transmit only 4 beams or 8 beams as the Set B of beams. The AI/ML model may then predict a larger set of beams, e.g., the Set A of beams.

The input into the AI/ML model may be measurement results based on measurements performed by the UE on the Set B of beams. The inputs may also include other inputs such as beam forming assumptions and configuration assumptions used by a base station to transmit the Set B of beams. The AI/ML model may use these inputs to predict a beam report for a Set A of beams, which may include a best beam from the Set A and/or L1-RSRP. The AI/ML model may reside at the UE or at the network (e.g., base station).

Beam management Case 1 (BM-Case1) relates to spatial-domain DL Tx beam prediction for Set A of beams based on measurement results of Set B of beams. Beam management Case 2(BM-Case2) relates to temporal DL Tx beam prediction for Set A of beams based on the historic measurement results of Set B of beams.

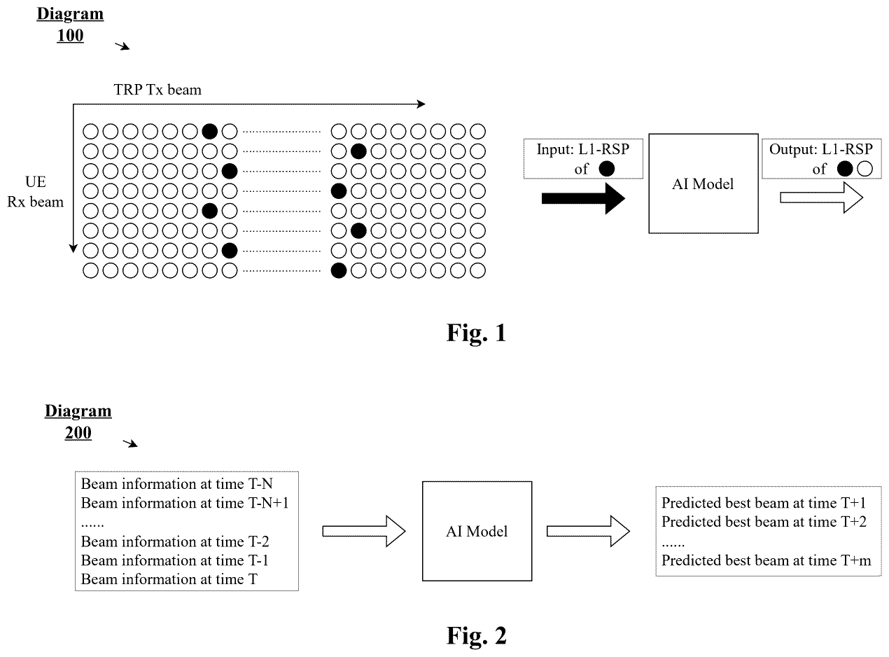

FIG. 1 shows a diagram 100 of spatial domain prediction according to one example. The diagram 100 shows a beam pattern of Tx beams and Rx beams. In BM Case 1, the UE measures a subset of beams (Set B) for input to the AI/ML model. The output of the AI/ML model comprises a quality of all beams and/or the ID of the Top-K beams.

FIG. 2 shows a diagram 200 of temporal domain prediction according to one example. In BM Case 2, the best beam at the future time T+m may be predicted by the AI/ML model based on the measurement results of more than one historical measurement time instance. The measurement results of the historical time instance may include the L1-RSRP of beams in set B in the last N history measurement instance. The number of predicted future time instances may be at least one. Each predicted future time instance may include multiple predicted beams.

AI/ML model life cycle management (LCM) refers to the development, deployment and management of an AI/ML model. There are two main categories of AI/ML LCM in the Third Generation Partnership (3GPP) Technical Specification (TSs), in particular, functionality-based LCM and model ID-based LCM. In functionality-based LCM, a functionality refers to a feature enabled by a configuration. For both functionality-based and model ID-based LCM, the UE may store the AI/ML model (with the associated model ID or functionality/configuration) and exchange this information with the network as capability information. Each AI/ML model ID or AI/ML functionality/configuration may be associated with conditions such that the model is valid only for a particular network vendor, cell site, and/or frequency band. Generally, the number of AI/ML models stored by the UE may be kept low in order to reduce the complexity, model storage and AI/ML model transfer requirements. AI/ML models may be transferred to the UE through some collaboration with the network. These AI/ML modeling frameworks are not mutually exclusive and may be used in combination.

The concept of additional conditions refers to non-standardized variables critical to AI/ML model training and operation. For example, in AI/ML-driven beam management, factors such as network topology (e.g., cell layout, antenna configurations) or UE-specific parameters (e.g., mobility speed) directly influence model selection during deployment. However, standardizing these variables is impractical, as they often involve proprietary implementations or sensitive operational data. Even though these variables may be used for training the AI/ML model and the AI/ML model operation requires these variables as input, these variables may not be standardized due to disclosure of proprietary information. Thus, classifying these variables as additional conditions may enable optimal AI/ML operation.

The associated ID is configured by the network as an abstract training data identifier and is used to reflect network-side additional conditions which may not be specified. The associated ID may correspond to particular sets of beam angles, beamwidths, antenna spacing, tilt angle, etc. The network may assign a separate associated ID for various different sets of conditions that affect beam transmission. However, not every difference in network-side additional conditions or network implementation has impacts on the UE side, e.g., UE assumptions, model training and model inference. Therefore, not every different network-side additional condition requires the assignment of a separate associated ID.

The term “functionality,” as used in 3GPP standards, was recently clarified, particularly in view of recent work on beam management. It is currently agreed that the term “functionality” may refer to one of at least three different types of functionalities including “supported functionalities,” “applicable functionalities,” and “activated functionalities.” Supported functionality may refer to UE-capability information/parameters, e.g., Rel-19 AI/ML-enabled Features or Feature Groups (FG). Applicable functionality may refer to inference-related parameters, e.g., the associated ID, reflecting additional conditions, e.g., beam transmission parameters, that may be indicated in CSI-ReportConfig for inference configuration. Activated functionality may refer to functionalities enabled for the UE based on the CSI framework. The meaning and granularity of “functionality” for Applicable functionalities, Activated functionalities and Supported functionalities may or may not be the same.

It was further agreed that the activation of an AI/ML functionality for, e.g., AI/ML BM or positioning use cases, may comprise a five operation procedure covering the main signaling operations from UE capability enquiry up to network provisioning and activation of the AI/ML functionality.

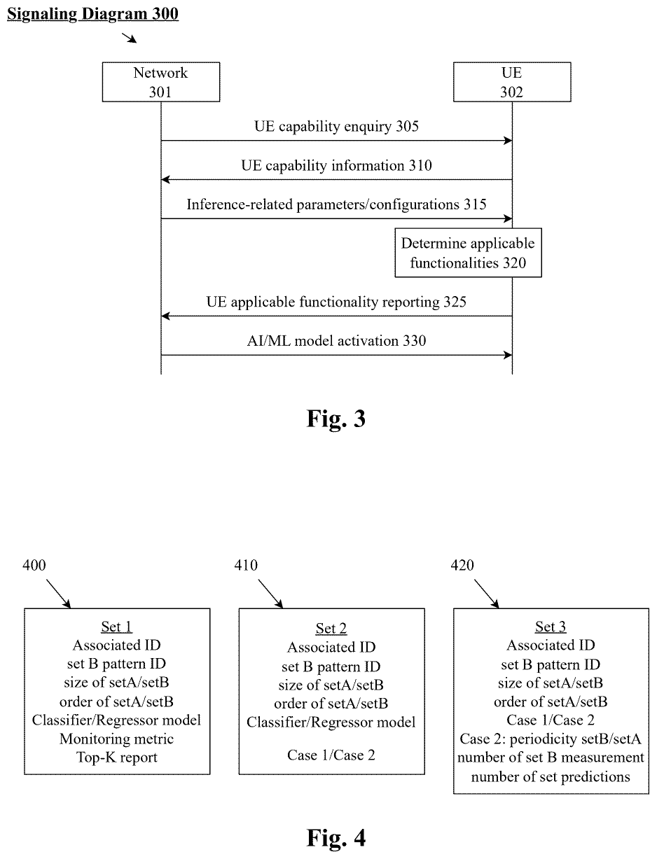

FIG. 3 shows a signaling diagram 300 for activating an functionality according to one example. The signaling diagram 300 includes a network 301, e.g., a gNB, and a UE 302.

In a first operation (305) the network 301 sends a UE capability inquiry (UECapabilityEnquiry) message to the UE 302 to initiate the procedure for the UE 302 to report its AI/ML supported functionalities.

In a second operation (310), the UE 302 sends a UE capability information message (UECapabilityInformation) to the network 301 containing supported functionalities at the UE side. The functionalities supported in 310 may have low granularity, e.g., BMCase1, BMCase2, etc.

In a third operation (315), the network 301 provides one or more configurations to the UE. In one example, the UE is enabled for uplink assistance information (UAI) reporting via OtherConfig. In another example, the network 301 may indicate network-side additional conditions corresponding to inference-related parameters according to at least two options, to be described in greater detail below.

In 320, the UE determines applicable functionalities based on the network-side additional conditions (if provided), UE-side additional conditions (internally known by UE) and model availability in the device.

In a fourth operation (325), the UE reports applicable functionalities in scenarios including, e.g., upon being configured to provide applicable functionalities, upon change of applicable functionalities via UAI, or as a response to network-side additional conditions requesting applicable functionality reporting in the third operation. In a fifth operation (330), the network activates an AI/ML functionality.

In the third operation (315), the UE may be configured to provide the applicability report based on one or both of the following two options. In a first option, the configuration may include one or more of CSI report configurations (CSI-ReportConfig) for inference configuration, wherein one or more associated IDs may be configured in the CSI framework. In a second option, the configuration may include one or more sets of inference related parameters for applicability reporting only (not for inference). The detailed information of the inference parameter set for the second option has not been agreed upon.

According to various example embodiments, a framework is described for triggering and reporting applicable functionalities for supported UE-side AI/ML models for air interface operations. Some example embodiments are described with regard to AI/ML beam management (BM), however, the principles described herein are not limited to BM. For example, aspects of the example framework may be applied in AI/ML positioning and/or AI/ML CSI reporting, as described below.

In some aspects of these example embodiments, the network may configure the UE for reporting applicable functionalities by indicating sets of inference parameters, e.g., containers including additional network-side conditions that impact the selection of an AI/ML model to activate for the UE. The example embodiments may relate to the second option described above for the third operation (315). The configuration of the inference parameter sets comprises a trigger for the UE to report its AI/ML capabilities. The network configures the UE to report applicable functionalities in view of the indicated inference parameters, to be described in further detail below.

In view of the UE response (the applicable functionality reporting of the fourth operation (325)), to be described in further detail below, the network may activate supported functionalities for a UE-side AI/ML model. In various example embodiments, the container is defined according to the following considerations. Examples of containers for sets of inference parameters are shown in FIG. 4, described in greater detail below.

In some example embodiments, each container may correspond to a particular functionality, e.g., CSI compression, BM case 1 or BM case 2, CSI prediction, etc., with the set of inference parameters for the functionality/applicability report. Each container may also include the associated ID as part of the parameter set, for reasons to be described in greater detail below.

In some example embodiments, the following parameters may be included in one or more sets of inference parameters (e.g., containers) provided by the network. Some of these parameters are mandatory for all cases (e.g., all supported functionalities including, e.g., BM case 1, BM case 2, CSI compression, CSI prediction, etc.) and some of these parameters are included only for some cases, to be described below. However, the parameters described herein are only examples and other parameters may be used for the listed example cases or different cases, e.g., positioning.

In some example embodiments, the inference parameters include an Associated ID parameter. The Associated ID links to non-observable network-side beam properties (e.g., beam codebook attributes like boresight direction, beamwidth, beam-index mapping). In some example embodiments, the inference parameters include a Pattern ID parameter. The Pattern ID defines the spatial/temporal mapping pattern between Set B (beam codebook) and Set A (reference signals). The Pattern ID may indicate a beam pattern such as, e.g., that shown in the diagram 100 of FIG. 1. In some example embodiments, the inference parameters include a Size of Set B parameter and a Size of Set A parameter. The Size of Set B defines the number of beam codebook entries for inference and the Size of Set A defines the number of beam codebook entries for prediction.

In some example embodiments, the Associated ID parameter, the Pattern ID parameter, and the Size of Set A/B parameters are mandatory. To ensure consistent mapping between Set B/Set A resources and the beam codebook, the inference parameter set must include the Associated ID and Pattern ID to resolve mapping ambiguities, along with the sizes of Set A and Set B to validate resource boundaries.

In some example embodiments, the inference parameters include an Indicated Report Content parameter. The Indicated Report Content specifies whether the UE reports raw measurements (e.g., CRI/SSBRI) or AI-predicted outcomes (e.g., Predicted_RSRP-CRI/SSBRI). This may be dependent on the type of AI model used, including, e.g., a classifier model or a regressor model.

In other example embodiments, the Indicated Report Content parameter may be mandatory. Given the integration of diverse AI models on the UE, the set must also specify the report content type (e.g., direct CRI/SSBRI measurements or AI-predicted RSRP with identifiers) to align reporting with network expectations.

In some example embodiments, the inference parameters include a BM Case Indicator parameter. The BM Case Indicator distinguishes between Case 1 (basic beam management) and Case 2 (predictive beam management with AI-driven future predictions).

In other example embodiments, the BM Case Indicator parameter may be mandatory for BM functionalities/configurations. The BM Case Indicator may be used to distinguish between the cases. For example, the UE may support only one of the cases for a given functionality and, if the same Associated ID is reused for both cases, the UE is enabled by the configuration to indicate support of one of the cases (case 1 or case 2).

In some example embodiments, the inference parameters include a Periodicity parameter. The periodicity parameter defines the periodicity of SetA/SetB. In some example embodiments, the inference parameters include a Number of Measurement Occasions parameter. The Number of Measurement Occasions defines the measurement instances per period for Set B/Set A. In some example embodiments, the inference parameters include a Number of Predicted Occasions parameter. The Number of Predicted Occasions defines the future prediction window length (e.g., time slots) for AI-predicted RSRP.

In other example embodiments, the periodicity parameter, the Number of Measurement Occasions parameter and the Number of Predicted Occasions parameter may be mandatory for BM-Case2 functionalities/configurations. These additional parameters may be used to synchronize AI-driven predictions with network scheduling requirements, ensuring temporal consistency and reliable beam management operations.

FIG. 4 shows three example sets of inference-related parameters indicated by a network to a UE in a request for applicable functionalities according to various example embodiments. A first set 400 may correspond to CSI compression and includes: Associated ID, set B pattern ID, size of setA/setB, order of setA/setB, Classifier/Regressor model, Monitoring metric, and Top-K report. A second set 410 may correspond to BM Case 1 and includes: Associated ID, set B pattern ID, size of setA/setB, order of setA/setB, Classifier/Regressor model, Case 1/Case 2. A third set 420 may correspond to BM Case 2 and includes: Associated ID, set B pattern ID, size of setA/setB, order of setA/setB, Case 1/Case 2, periodicity setB/setA (Case 2), number of set B measurements (Case 2), and number of set predictions (Case 2).

In some aspects of the example embodiments, the UE may report supported applicable functionalities to the network by a bitmap indicator. To streamline UE capability reporting for AI/ML-based beam management inference, a unified applicability report may be adopted for the fourth operation (325) to support both Option A (CSI-ReportConfig) and Option B (inference parameter sets).

In some example embodiments, this report may include a bitmap indicator to dynamically signal the applicability status of individual configurations, along with optional UE-supported parameter sets to assist the network in beam-codebook optimization. The bitmap indicator may comprise a bitmask where each bit corresponds to (e.g., maps to) a specific CSI-ReportConfig or inference parameter set. The bits may be mapped to the configuration/parameter sets based on an index. In some example embodiments, bit value 1 indicates the configuration/set to which the bit is mapped is applicable (supported and aligned with UE capabilities); 0 indicates incompatibility. Accordingly, a single report structure may accommodate both CSI-ReportConfig(s) (Option A) and inference parameter sets (Option B).

In some example embodiments, if the UE cannot support any configurations signaled by the network, the UE may explicitly report the subset of supported inference parameter sets (e.g., valid combinations of Associated ID, Pattern ID, BM Case, etc.). To ensure continuity in AI/ML-based beam management, when all configurations provided by the network in the third operation (315) (both Option A: CSI-ReportConfigs and Option B: inference parameter sets) are unsupported by the UE, the UE shall mandatorily report its supported inference parameter set(s) within the unified applicable report in the fourth operation (325). This enables the network to reconfigure feasible beam-codebook mappings aligned with UE capabilities.

In other example embodiments embodiment, the UE triggers this reporting only if all configurations (CSI-ReportConfigs and inference parameter sets) signaled by the network in the third operation (315) are marked as inapplicable (e.g., bitmap=all zeros).

In some example embodiments, the UE may report supported inference parameter set(s). Valid combinations of parameters the UE may provide include: Associated ID; Pattern ID; size of Set A/B; BM Case (Case 1 or Case 2); and Case 2-specific parameters (e.g., Periodicity of Set A/B, Number of Predicted Occasions), if supported. In some example embodiments, if multiple supported inference parameter sets are reported, the UE may (optionally) rank supported sets to indicate UE preference (e.g., computational efficiency, power constraints).

The associated ID encapsulates network-side beam properties (e.g., beam codebook parameters such as boresight direction, 3 dB beamwidth, and beam-index mapping order) that influence AI/ML-based beam management performance but are not directly observable or configurable via the air interface. Crucially, the associated ID does not enforce a one-to-one mapping with inference configurations (e.g., Set A/Set B parameters), as training/inference consistency cannot be maintained even when the same associated ID is reused across distinct configurations. For example, during training, the network may retain a fixed associated ID while varying data collection configurations (e.g., Set A/Set B sizes, patterns), enabling the UE to train separate AI models for each configuration-ID combination.

In some example embodiments, during inference, the UE leverages both the associated ID and the inference report configuration (containing Set A/Set B details) to select the appropriate model to activate, ensuring alignment with the network's unobservable beam properties. This approach allows a single associated ID to represent consistent underlying beam conditions while supporting flexible mapping to multiple inference configurations, decoupling UE model selection from static ID dependencies.

During training, the network may retain a fixed associated ID while varying data collection configurations (e.g., Set A/Set B sizes, patterns), enabling the UE to train separate AI models for each configuration-ID combination.

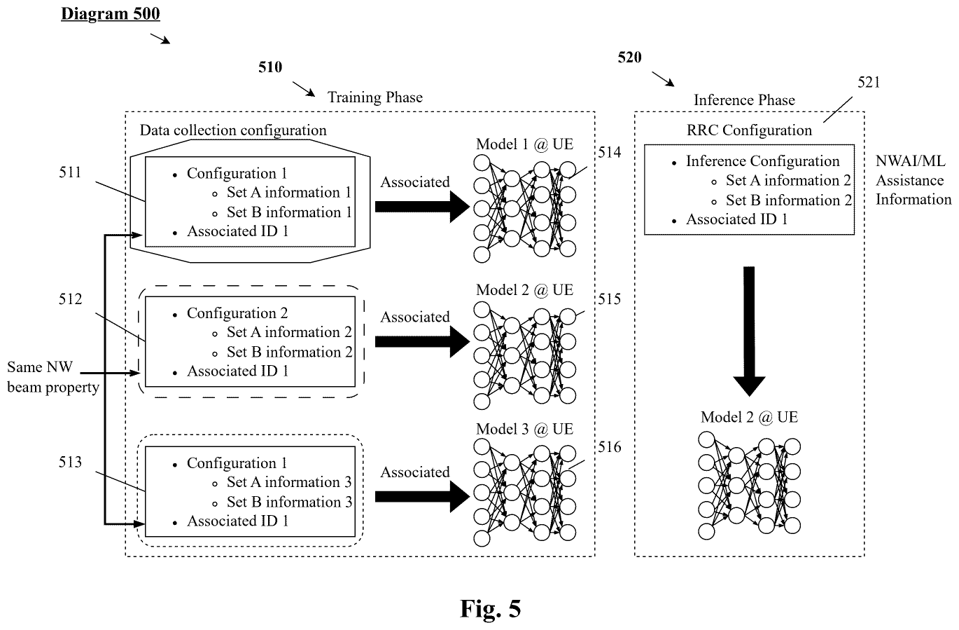

FIG. 5 shows a diagram 500 of an example training phase 510 in which the same associated ID is associated with multiple data collection configurations and an example inference configuration 520 indicating one of the data collection configurations according to various example embodiments. In this example, the training phase 510 includes a first configuration 511 indicating first data collection configurations for Set A and Set B, a second configuration 512 indicating second data collection configurations for Set A and Set B, and a third configuration 513 indicating third data collection configurations for Set A and Set B. Each of the three configurations includes the same associated ID, e.g., associated ID1. Accordingly, the UE trains three separate models, e.g., a first model 514 based on the first data collection configuration 511, a second model 515 based on the second data collection configuration 512, and a third model 516 based on the third data collection configuration 513.

In this example, the inference phase 520 includes an RRC configuration 521 indicating the second configuration 512, e.g., as network AI/ML assistance information, so that the UE may select the correct model (the second model 515) to activate for model inference.

In some example embodiments, for model inference, Set A and Set B may be configured as different csi-ResourceSets within a csi-ResourceConfig or as different csi-ResourceConfig within a csi-ReportConfig. In some example embodiments, during inference, the UE leverages either the associated ID or the inference bitmap indicator (containing Set A/Set B details) to select the appropriate model through the bitmap signaling.

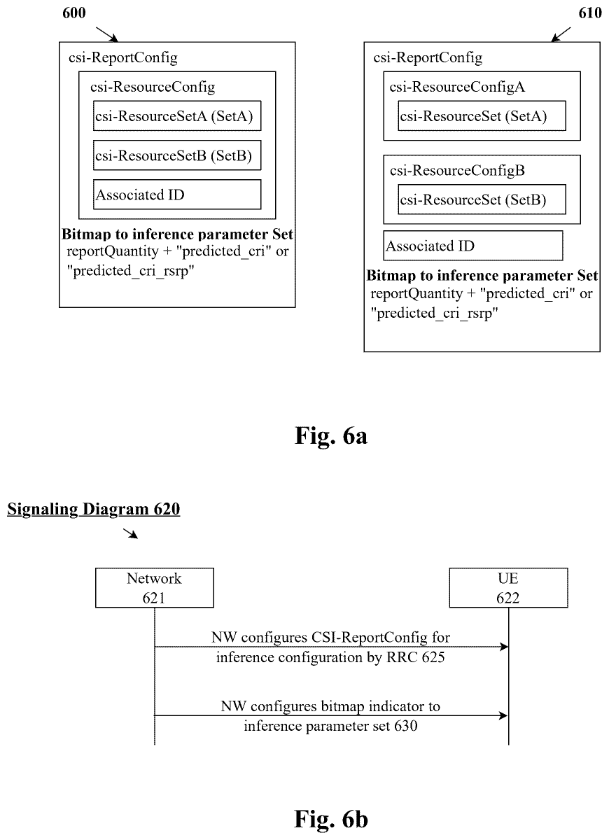

FIG. 6a shows CSI report configurations for inference including bitmaps indicating sets of inference parameters according to various example embodiments. A first CSI report configuration 600 includes an associated ID shared among both Set A and Set B. In particular, the first CSI report configuration includes a CSI resource configuration (csi-ResourceConfig) including both a CSI resource for Set A (csi-ResourceSetA) and a CSI resource for Set B (csi-ResourceSetB) and a single associated ID corresponding to both resources. A second CSI report configuration 610 includes separate CSI resource configurations for Set A and Set B. In particular, the second CSI report configuration 610 includes a first CSI resource configuration (csi-ResourceConfigA) including a CSI resource for Set A (csi-ResourceSet), a second CSI resource configuration (csi-ResourceConfigB) including a second CSI resource for Set B (csi-ResourceSet), and an Associated ID. Additionally, each of the first CSI report configuration 600 and the second CSI report configuration 610 include a bitmap indicating one or more inference parameter sets.

FIG. 6b shows a signaling diagram 620 for indicating an inference model according to various example embodiments. The signaling diagram 620 includes a network 621, e.g., a gNB, and a UE 622. In 625, according to a first option, the network configures a CSI report configuration indicating an associated ID for an inference configuration via RRC. In 630, according to a second option, the network configures a bitmap indicator to the inference parameter set. It is noted that the second option of 630 is preferred due to the granularity of information included and the enhanced capacity to identify the correct AI/ML model.

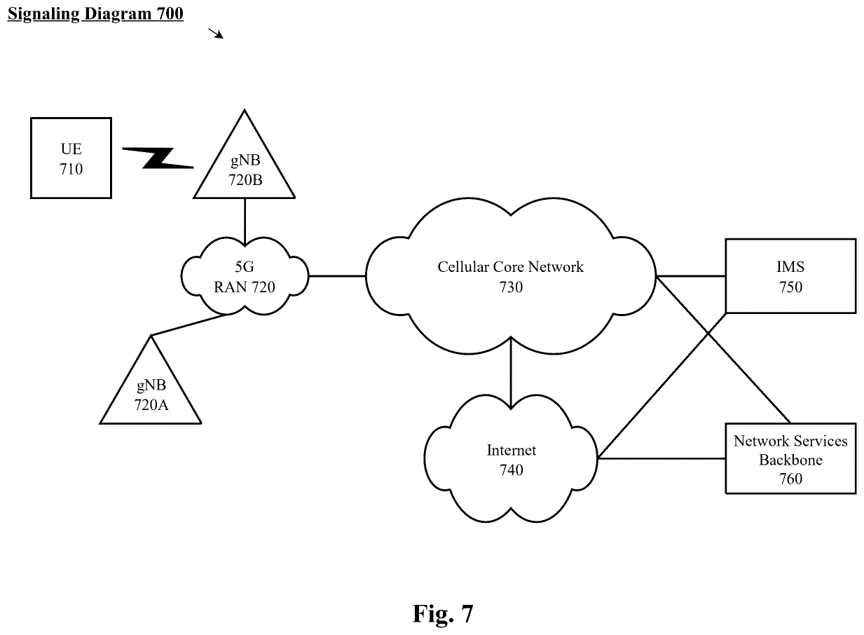

FIG. 7 shows an example network arrangement 700 according to various example embodiments. The example network arrangement 700 includes a UE 710. The UE 710 may be any type of electronic component that is configured to communicate via a network, e.g., mobile phones, tablet computers, desktop computers, smartphones, embedded devices, wearables, Internet of Things (IoT) devices, etc. An actual network arrangement may include any number of UEs being used by any number of users. Thus, the example of one UE 710 is merely provided for illustrative purposes.

The UE 710 may be configured to communicate with one or more networks. In the example of the network arrangement 700, the network with which the UE 710 may wirelessly communicate is a 5G NR radio access network (RAN) 720. However, the UE 710 may also communicate with other types of networks (e.g., 5G cloud RAN, a next generation RAN (NG-RAN), a legacy cellular network, etc.) and the UE 710 may also communicate with networks over a wired connection. With regard to the example embodiments, the UE 710 may establish a connection with the 5G NR RAN 720. Therefore, the UE 710 may have a 5G NR chipset to communicate with the NR RAN 720.

The 5G NR RAN 720 may be portions of a cellular network that may be deployed by a network carrier (e.g., Verizon, AT&T, T-Mobile, etc.). The RAN 720 may include cells or base stations that are configured to send and receive traffic from UEs that are equipped with the appropriate cellular chip set. In this example, the 5G NR RAN 720 includes the gNB 720A and the gNB 720B. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Any association procedure may be performed for the UE 710 to connect to the 5G NR RAN 720. For example, as discussed above, the 5G NR RAN 720 may be associated with a particular network carrier where the UE 710 and/or the user thereof has a contract and credential information (e.g., stored on a SIM card). Upon detecting the presence of the 5G NR RAN 720, the UE 710 may transmit the corresponding credential information to associate with the 5G NR RAN 720. More specifically, the UE 710 may associate with a specific cell (e.g., gNB 720A).

The network arrangement 700 also includes a cellular core network 730, the Internet 740, an IP Multimedia Subsystem (IMS) 750, and a network services backbone 760. The cellular core network 730 manages the traffic that flows between the cellular network and the Internet 740. The IMS 750 may be generally described as an architecture for delivering multimedia services to the UE 710 using the IP protocol. The IMS 750 may communicate with the cellular core network 730 and the Internet 740 to provide the multimedia services to the UE 710. The network services backbone 760 is in communication either directly or indirectly with the Internet 740 and the cellular core network 730. The network services backbone 760 may be generally described as a set of components (e.g., servers, network storage arrangements, etc.) that implement a suite of services that may be used to extend the functionalities of the UE 710 in communication with the various networks.

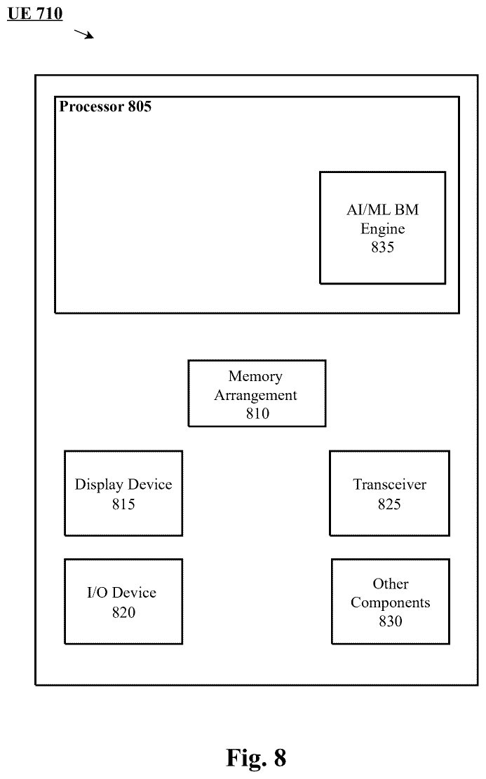

FIG. 8 shows an example UE 710 according to various example embodiments. The UE 710 will be described with regard to the network arrangement 700 of FIG. 7. The UE 710 may represent any electronic device and may include a processor 805, a memory arrangement 810, a display device 815, an input/output (I/O) device 820, a transceiver 825, and other components 830. The other components 830 may include, for example, an audio input device, an audio output device, a battery that provides a limited power supply, a data acquisition device, ports to electrically connect the UE 710 to other electronic devices, sensors to detect conditions of the UE 710, etc.

The processor 805 may be configured to execute a plurality of engines for the UE 710. For example, the engines may include an AI/ML engine 835 for performing operations related to applicability reporting for a UE-side AI/ML model, as described in detail above.

In some examples, beam measurement inputs may be fed to the AI/ML engine 835. The AI/ML engine 835 may include one or more learning-based and/or non-learning-based models for perceiving, synthesizing, and inferring information. The AI/ML engine 835 may include any suitable number of processes to predict a beam in the spatial or temporal domain based on input beam measurement data.

Persons of ordinary skill in the art will appreciate that the AI/ML engine 835 may include any suitable machine learning models that are well-known or widely available such as regression techniques, classification techniques, neural networks, and deep learning networks. In instances where the AI/ML engine 835 comprises a machine-learning based model, the AI/ML engine 835 may be trained to predict a beam based on beam measurement data using one or more well-known or widely available training techniques such as supervised learning, semi-supervised learning, unsupervised learning, and/or reinforcement learning techniques. The training data may include the aforementioned beam measurement data.

The above referenced engine being an application (e.g., a program) executed by the processor 805 is only an example. The functionality associated with the engines may also be represented as a separate incorporated component of the UE 710 or may be a modular component coupled to the UE 710, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 805 is split among two or more processors such as a baseband processor and an applications processor. The example embodiments may be implemented in any of these or other configurations of a UE.

The memory arrangement 810 may be a hardware component configured to store data related to operations performed by the UE 710. The display device 815 may be a hardware component configured to show data to a user while the I/O device 820 may be a hardware component that enables the user to enter inputs. The display device 815 and the I/O device 820 may be separate components or integrated together such as a touchscreen.

The transceiver 825 may be a hardware component configured to establish a connection with the 5G NR-RAN 720, an LTE-RAN (not pictured), a legacy RAN (not pictured), a WLAN (not pictured), etc. Accordingly, the transceiver 825 may operate on a variety of different frequencies or channels (e.g., set of consecutive frequencies). The transceiver 825 includes circuitry configured to transmit and/or receive signals (e.g., control signals, data signals). Such signals may be encoded with information implementing any one of the methods described herein. The processor 805 may be operably coupled to the transceiver 825 and configured to receive from and/or transmit signals to the transceiver 825. The processor 805 may be configured to encode, decode and/or process signals (e.g., signaling from a base station of a network) for implementing any one of the methods described herein.

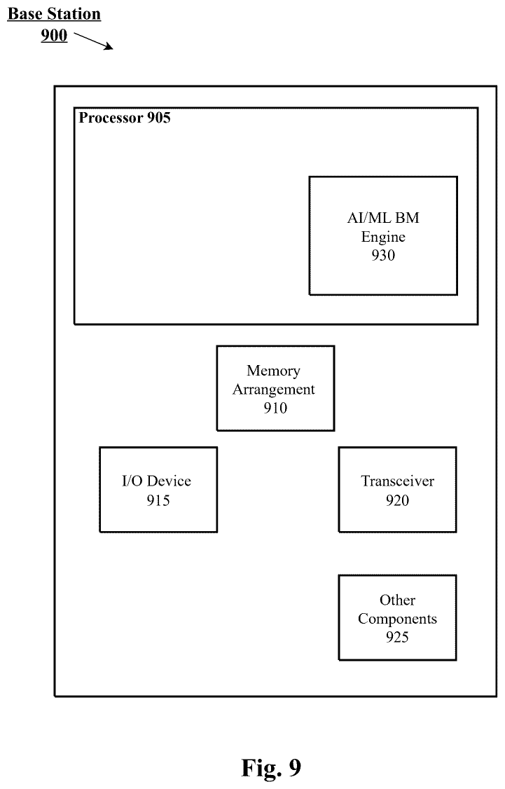

FIG. 9 shows an example base station 900 according to various example embodiments. The base station 900 may represent the gNB 720A, the gNB 720B or any other access node through which the UE 710 may establish a connection and manage network operations. The base station 900 may operate as the MN or the SN as described in the examples above.

The base station 900 may include a processor 905, a memory arrangement 910, an input/output (I/O) device 915, a transceiver 920, and other components 925. The other components 925 may include, for example, an audio input device, an audio output device, a battery, a data acquisition device, ports to electrically connect the base station 500 to other electronic devices and/or power sources, etc.

The processor 905 may be configured to execute a plurality of engines for the UE 710. For example, the engines may include an AI/ML engine 930 for performing operations related to applicability reporting for a UE-side AI/ML model, as described in detail above.

The memory arrangement 910 may be a hardware component configured to store data related to operations performed by the base station 900. The I/O device 915 may be a hardware component or ports that enable a user to interact with the base station 900.

The transceiver 920 may be a hardware component configured to exchange data with the UE 710 and any other UE in the network arrangement 700. The transceiver 920 may operate on a variety of different frequencies or channels (e.g., set of consecutive frequencies). The transceiver 920 includes circuitry configured to transmit and/or receive signals (e.g., control signals, data signals). Such signals may be encoded with information implementing any one of the methods described herein. The processor 905 may be operably coupled to the transceiver 920 and configured to receive from and/or transmit signals to the transceiver 920. The processor 905 may be configured to encode, decode and/or process signals (e.g., signaling from a UE) for implementing any one of the methods described herein.

### EXAMPLES

In a first example, a method, comprising processing, based on signaling from a network, a configuration for reporting applicable functionalities for models, the configuration including at least one associated identifier (ID) for models supported by the network or at least one parameter set including the associated ID, each associated ID associated with parameters related to beam transmission during inference operations and generating a bitmap in which each bit indicates whether a respective associated ID or respective parameter set is supported.

In a second example, the method of the first example, further comprising, when the bitmap indicates no support of any configured associated IDs or parameter sets, triggering reporting of one or more sets of parameters, each set of parameters including a supported associated ID and supported inference parameters.

In a third example, the method of the second example, wherein the supported inference parameters include a pattern ID parameter for defining a mapping pattern between Set B and Set A and size parameters for the Set B and the Set A.

In a fourth example, the method of the second example, wherein the supported inference parameters include a beam management (BM) case indicator parameter distinguishing between BM Case 1 and BM Case 2.

In a fifth example, the method of the second example, wherein the supported inference parameters include a periodicity parameter, a number of measurement occasions parameter, and a number of predicted occasions parameter.

In a sixth example, the method of the first example, wherein the configuration comprises a CSI report configuration indicating at least one associated ID implicitly associated with additional conditions for beam transmission.

In a seventh example, the method of the first example, wherein the configuration comprises at least one set of inference-related parameters.

In an eighth example, the method of the seventh example, wherein each set of inference-related parameters corresponds to a functionality including one of beam management (BM) case 1, BM case 2, channel state information (CSI) compression, or CSI prediction.

In a ninth example, the method of the eighth example, wherein each set of inference-related parameters includes an associated ID parameter for indicating network-side additional conditions, a pattern ID parameter for indicating a mapping pattern between Set B and Set A and size parameters for the Set B and the Set A.

In a tenth example, the method of the ninth example, wherein each set of inference-related parameters includes a report content type parameter indicating a type of contents for an inference report.

In an eleventh example, the method of the tenth example, wherein at least one set of inference-related parameters includes a beam management (BM) case indicator parameter distinguishing between BM Case 1 and BM Case 2.

In a twelfth example, the method of the tenth example, wherein at least one set of inference-related parameters includes a periodicity parameter, a number of measurement occasions parameter, and a number of predicted occasions parameter.

In a thirteenth example, the method of the first example, further comprising generating, for transmission to the network, a message comprising the bitmap to report the applicable functionalities and processing a configuration for an inference report activating at least one applicable functionality.

In a fourteenth example, the method of the thirteenth example, wherein the configuration for the inference report includes at least one associated ID and a bitmap for indicating a data collection configuration used for training a stored model.

In a fifteenth example, the method of the fourteenth example, wherein the inference report includes a channel state information (CSI) resource configuration including both Set A and Set B with a single associated ID.

In a sixteenth example, the method of the fourteenth example, wherein the inference report includes a first channel state information (CSI) resource configuration includes for Set A and a first associated ID and a second CSI resource configuration for Set B and a second associated ID.

In a seventeenth example, a processor configured to perform any of the methods of the first through sixteenth examples.

In an eighteenth example, a user equipment (UE) configured to perform any of the methods of the first through sixteenth examples.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

Some embodiments described herein may include use of learning and/or non-learning-based process(es). The use may include collecting, pre-processing, encoding, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML beam management processes may be used to benefit users.

For example, the data may be used to train models that may be deployed to improve performance, accuracy, and/or functionality of applications and/or services. Accordingly, the use of the data enables the AI/ML beam management processes to adapt and/or optimize operations to provide more personalized, efficient, and/or enhanced user experiences. Such adaptation and/or optimization may include tailoring content, recommendations, and/or interactions to individual users, as well as streamlining processes, and/or enabling more intuitive interfaces. Further beneficial uses of the data in the AI/ML beam management processes are also contemplated by the present disclosure.

The present disclosure contemplates that, in some example embodiments, data used by AI/ML beam management processes includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML beam management processes, should attempt to comply with well-established privacy policies and/or privacy practices.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising memory coupled to processing circuitry, the processing circuitry configured to:
process, based on signaling from a network, a configuration for reporting applicable functionalities for models, the configuration including at least one associated identifier (ID) for models supported by the network or at least one parameter set including the associated ID, each associated ID associated with parameters related to beam transmission during inference operations; and
generate a bitmap in which each bit indicates whether a respective associated ID or respective parameter set is supported.

2. The apparatus of claim 1, wherein the processing circuitry is further configured to:
when the bitmap indicates no support of any configured associated IDs or parameter sets, trigger reporting of one or more sets of parameters, each set of parameters including a supported associated ID and supported inference parameters.

3. The apparatus of claim 2, wherein the supported inference parameters include a pattern ID parameter for defining a mapping pattern between Set B and Set A and size parameters for the Set B and the Set A.

4. The apparatus of claim 2, wherein the supported inference parameters include a beam management (BM) case indicator parameter distinguishing between BM Case 1 and BM Case 2.

5. The apparatus of claim 2, wherein the supported inference parameters include a periodicity parameter, a number of measurement occasions parameter, and a number of predicted occasions parameter.

6. The apparatus of claim 1, wherein the configuration comprises a CSI report configuration indicating at least one associated ID implicitly associated with additional conditions for beam transmission.

7. The apparatus of claim 1, wherein the configuration comprises at least one set of inference-related parameters.

8. The apparatus of claim 7, wherein each set of inference-related parameters corresponds to a functionality including one of beam management (BM) case 1, BM case 2, channel state information (CSI) compression, or CSI prediction.

9. The apparatus of claim 8, wherein each set of inference-related parameters includes an associated ID parameter for indicating network-side additional conditions, a pattern ID parameter for indicating a mapping pattern between Set B and Set A and size parameters for the Set B and the Set A.

10. The apparatus of claim 9, wherein each set of inference-related parameters includes a report content type parameter indicating a type of contents for an inference report.

11. The apparatus of claim 10, wherein at least one set of inference-related parameters includes a beam management (BM) case indicator parameter distinguishing between BM Case 1 and BM Case 2.

12. The apparatus of claim 10, wherein at least one set of inference-related parameters includes a periodicity parameter, a number of measurement occasions parameter, and a number of predicted occasions parameter.

13. The apparatus of claim 1, wherein the processing circuitry is further configured to:
generate, for transmission to the network, a message comprising the bitmap to report the applicable functionalities; and
process a configuration for an inference report activating at least one applicable functionality.

14. The apparatus of claim 13, wherein the configuration for the inference report includes at least one associated ID and a bitmap for indicating a data collection configuration used for training a stored model.

15. The apparatus of claim 14, wherein the inference report includes a channel state information (CSI) resource configuration including both Set A and Set B with a single associated ID.

16. The apparatus of claim 14, wherein the inference report includes a first channel state information (CSI) resource configuration includes for Set A and a first associated ID and a second CSI resource configuration for Set B and a second associated ID.
